(19) United States
(12) Patent Application Publication
(10) Pub. No.: US 2011/0314425 A1
(43) Pub. Date: Dec. 22, 2011

(54) Air gesture recognition type electronic device operating method

(75) Inventor: Chiu-Lin Chiang, Taipei City (TW)

(73) Assignee: HOLY STONE ENTERPRISE CO., LTD., Taipei City (TW)

(21) Appl. No.: 12/801,585

(22) Filed: Jun. 16, 2010

(51) Int. Cl. G06F 3/01

(52) U.S. Cl. 715/863

(57) ABSTRACT

An air gesture recognition type electronic device operating method for operating an electronic device having multiple sensors in each of multiple peripheral sides thereof by: approaching an object to the sensors to produce sensing signals and determining whether or not the object has been continuously sensed, and then determining whether or not the moving direction and moving speed of the object match a respective predetermined value, and then coupling and computing all received sensing signals to produce an operating parameter for running an air gesture application procedure. Thus, a user can operate the electronic device without direct contact or the use of any camera or input media, saving the hardware cost and enhancing the operational flexibility.

### BACKGROUND OF THE INVENTION

1. Field of the Invention

The present invention relates to a method of operating an electronic device and more particularly, to an air gesture recognition type electronic device operating method for inputting control signals into the electronic device without direct contact.

2. Description of the Related Art

Following fast development of the modern technology and electronic industry, many different kinds of consumer electronics, such as computer, display device and digital TV have entered into our daily life. Further, an electronic device is generally equipped with an input device, such as mouse, keyboard or key switches for data input. When using a mouse to operate a computer, the mouse must be placed on the desk or a flat surface. Due to the constraint of the mouse, the user must sit in front of the computer when using the computer. The use of the input device increases the installation cost of the computer and limits the operational flexibility of the computer.

In view of the operational inconvenience due to the use of an input device in an electronic system, many advanced electronic devices operable without any attached input device are created. For example, touch panel is an electronic visual output that can detect the presence of location of the touch or contact to the display area by a finger, hand, pen or other passive objects. A touch panel enables one to interact with what is displayed directly on the hand, and lets one do so without requiring any intermediate device. A touch panel can be attached to computers or any of a variety of other electronic devices. Nowadays, touch panel has been intensively used in communication equipment, household appliances, entertainment appliances, IA products, medical instruments and etc.

However, when operating a touch panel, the user needs to touch the screen of the touch panel directly. Thus, the user must stand closer to the electronic device so that the user's finger or hand can touch the screen of the touch panel of the electronic device to input a command. This operating method still brings inconvenience. In order to eliminate this drawback, vision-based human computers are created. These vision-based human computers detect hand gesture, body language interpretation and/or facial expression interpretation. Researches continue to improve point gesture recognition technology. Air gesture recognition technology has been effectively used in TV, computer or projector as an effective human machine interface system.

At present, the application of air gesture recognition technology requires a camera to pick up the gesture of the user's hand or body for analyzing the moving direction of the user's hand or body and running a corresponding input procedure subject to the result of the computation. The use of the camera requires an extra cost.

Therefore, it is desirable to provide an air gesture recognition type electronic device that is operable without any attached input device or camera.

### SUMMARY OF THE INVENTION

The present invention has been accomplished under the circumstances in view. It is one object of the present invention to provide an air gesture recognition type electronic device operating method, which enables the user to input control signals into the electronic device within a predetermined range without direct contact, enhancing operational flexibility. It is another object of the present invention to provide an air gesture recognition type electronic device operating method, which achieves air gesture recognition without any camera, saving the hardware cost. It is still another object of the present invention to provide an air gesture recognition type electronic device operating method, which saves power consumption when the electronic device is not operated.

To achieve these and other objects of the present invention, an air gesture recognition type electronic device operating method, which enables a user to operate an electronic device that has multiple sensors in each of multiple peripheral sides thereof by: approaching an object to the sensors to produce sensing signals and determining whether or not the object has been continuously sensed, and then determining whether or not the moving direction and moving speed of the object match a respective predetermined value, and then coupling and computing all received sensing signals to produce an operating parameter for running an air gesture application procedure. Thus, a user can operate the electronic device without direct contact or the use of any camera or input media, saving the hardware cost and enhancing the operational flexibility.

In an alternate form of the present invention, the air gesture recognition type electronic device operating method includes the step of preparing an electronic device having multiple sensors in each of multiple peripheral sides thereof and then providing multiple objects for approaching the sensors of the electronic device to produce sensing signals, the step of determining whether or not at least one object is approaching, the step of determining whether or not multiple sensing signals have been produced and whether or not these sensing signals are continuous sensing signals, the step of determining whether or not the moving directions of the sensed objects are different and whether or not the moving direction/speed of each sensed object matches a predetermined value, the step of coupling and computing all received sensing signals to produce an operating parameter, and the step of running an air gesture application procedure subject to the produced operating parameter.

Further, when one object is sensed by one sensor, the electronic device is switched from a power-saving mode to an operating mode. This wakeup mode saves power consumption when the electronic device is not operated.

### BRIEF DESCRIPTION OF THE DRAWINGS

FIG. 1 is a flow chart of an air gesture recognition type electronic device operating method in accordance with a first embodiment of the present invention.

FIG. 2 is a circuit block diagram of the present invention.

FIG. 3 is a schematic applied view of the first embodiment of the present invention (I).

FIG. 4 is a schematic applied view of the first embodiment of the present invention (II).

FIG. 5 is a flow chart of an air gesture recognition type electronic device operating method in accordance with a second embodiment of the present invention.

FIG. 6 is a schematic applied view of the second embodiment of the present invention.

### DETAILED DESCRIPTION OF THE PREFERRED EMBODIMENT

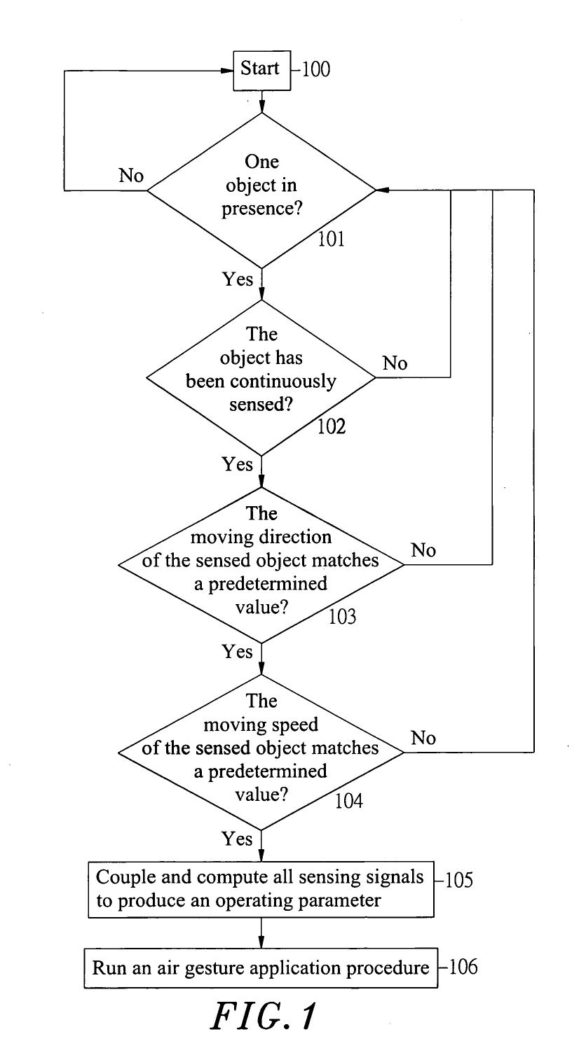

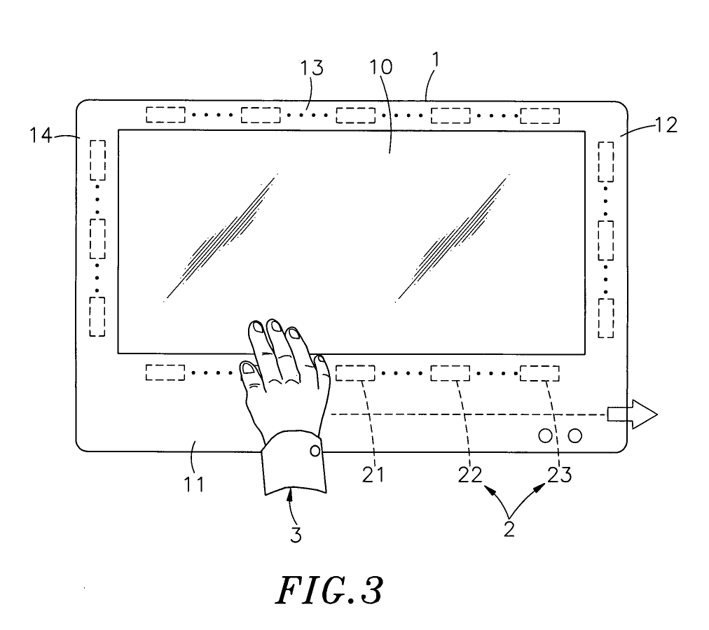

Referring to FIGS. 1, 2, 3 and 4, an air gesture recognition type electronic device operating method in accordance with a first embodiment of the present invention is to be applied for operating an electronic device 1 that can be a computer, TV or display device.

According to the present preferred embodiment, the electronic device 1 is a display device. The display device 1 has four peripheral sides, namely, the first peripheral side 11, the second peripheral side 12, the third peripheral side 13 and the fourth peripheral side 14 disposed around a rectangular screen 10 thereof, and a plurality of sensor means mounted in each of the four peripheral sides 11-14. The first peripheral side 11 and the third peripheral side 13 are disposed opposite to each other. The second peripheral side 12 and the fourth peripheral side 14 connected between the first peripheral side 11 and the third peripheral side 13 at two opposite lateral sides. The sensors can be capacitive sensor or infrared sensors. Exemplars of the electrical switching means can be seen in U.S. Pat. Nos. 7,498,749; 7,443,101; 7,336,037.

The electronic device operating method uses an object 3 for input control. Further, as an example of the present invention, a first sensor 21, a second sensor 22 and a third sensor 23 are installed in the first peripheral side 11 of the display device 1 and electrically connected to a control module 20 at a circuit board 2 inside the display device 1. The air gesture recognition type electronic device operating method in accordance with the first embodiment of the present invention includes the steps of:
(100) Prepare an electronic device 1 having multiple sensors in each of multiple peripheral sides thereof, and then provide at least one object 3 for approaching the sensors of the electronic device 1 to produce sensing signals;
(101) Determine whether or not one object 3 is approaching, and then proceed to step (102) when positive, or return to step (100) when negative;
(102) Determine whether or not the object 3 has been continuously sensed, and then proceed to step (103) when positive, or return to step (101) when negative;
(103) Determine whether or not the moving direction of the sensed object 3 matches a predetermined value, and then proceed to step (104) when positive, or return to step (101) when negative;
(104) Determine whether or not the moving speed of the sensed object 3 matches a predetermined value, and then proceed to step (105) when positive, or return to step (101) when negative;
(105) Couple and compute all sensing signals to produce an operating parameter; and
(106) Run an air gesture application procedure.

When one object 3, for example, the user's fingers enter the set sensing range of the first sensor 21 in the first peripheral side 11 of the display device 1, for example, the range X within 10-25 cm, the first sensor 21 senses the presence of the object 3 and produces a sensing signal. When the object 3 moves away from the set sensing range of the first sensor 21 into the set sensing range of the second sensor 22 in the first peripheral side 11 of the display device 1, for example, the range X within 10-25 cm, the second sensor 22 senses the presence of the object 3 and produces a sensing signal. Subject to the sensing signal from the first sensor 21 and the sensing signal from the second sensor 22, a continuous sensing is confirmed by the control module 20. Further, the control module 20 stores the sensing signals received from the first sensor 21 and the second sensor 22 in a built-in memory or an external memory that is electrically connected to the control module 20.

Thereafter, the control module 20 determines whether or not the moving direction and speed of the sensed object 3 matched a respective predetermined value that is stored in the built-in memory or the external memory that is electrically connected to the control module 20. When matched, the control module 20 couples and analyzes all the received sensing signals to produce an operating parameter. The sensing signal produced by each sensor comprises the data of, but not limited to, distance, direction and speed. The computation is made subject to the formula of:

Ag=S₁{f(d),f(t)}·S₂{f(d),f(t)} . . . S_{y}{f(d),f(t)}

where:

Ag (air gesture operation)=the operating parameter;

S=sensor;

S₁=the first sensor;

S₂=the second sensor;

S_{y}=the y^{th} sensor;

f(d)=the distance between the sensed object 3 and the sensor sensing the object 3;

f(t)=the moving time from one sensor to a next sensor.

Calculation of the moving time is made by: defining the time of the first contact to be the first time point t₁ and the time of the last contact to be the second time point t₂, and then obtaining the moving time by the formula of t₂−t₁. Thus, the control module 20 can couple and analyze the sensing signals received from the sensors to produce an operating parameter. According to the present preferred embodiment, the operating parameter comprises the data of, but not limited to, the moving direction of the sensed object 3, the distance between the sensed object 3 and the respective sensor, and the moving speed of the sensed object 3. Subject to the operating parameter thus produced, an air gesture application program is performed.

The arrangement of the first sensor 21, second sensor 22 and third sensor 23 in the first peripheral side 11 of the display device 1 is simply an example of the present invention. However, this example is simply for the purpose of illustration only but not for use as a limitation. According to the aforesaid operation flow, the control module 20 determines whether or not the object 3 has been continuously sensed by the first sensor 21, the second sensor 22 and the third sensor 23. When the object 3 is continuously sensed by the first sensor 21, the second sensor 22 and the third sensor 23, it is judged to be a continuous sensing status. Thereafter, the control module 20 determines the moving direction of the object 3 subject to the sequence of the sensing signals received. Subject to the calculation formula Ag=S₁{f(d), f(t)}·S₂{f(d), f(t)} . . . S_{y}{f(d), f(t)}, it is known that the object 3 moves relative to the first peripheral side 11 from the left toward the right. Thereafter, the distance between the object 3 and the first sensor 21 and the distance between the object 3 and the second sensor 22 are determined subject to f(d). Thereafter, subject to f(t), the moving speed of the object 3 is determined to be in conformity with the set value or not. For example, if the time period from the first time point t₁ to the second time point t₂ is 5-6 seconds and the distances between the object 3 and the first sensor 21, second sensor 22 and third sensor 33 are equal and all to be 5 cm, it is determined to be an operation for volume control. On the other hand, when the control module 20 received sensing signals from the first sensor 21, the second sensor 22 and the third sensor 23 within a predetermined time period, the time period from the first time point t₁ to the second time point t₂ during movement of the object 3 is shorter than one second, and the distances between the object 3 and the first sensor 21, second sensor 22 and third sensor 33 are equal and all to be 5 cm, thus it is determined to be an operation for turning to the next page. However, it is to be understood that the above explanation is simply an example of the present invention and shall not be considered to be limitations of the invention.

According to the present invention, the electronic device 1 has stored therein multiple operating parameters, such as the value defined for next page operation, the parameter for volume control, or the parameter for picture rotation. Further, the invention uses the control module 20 to receive sensing signals from the sensors, and uses a formula to calculate the content of the sensing signals. If the content of one sensing signal obtained through calculation matches one pre-set operating parameter, the control module 20 executes the corresponding application program and operating software procedure. Thus, the user can input control signals into the electronic device 1 within a predetermined range without direct contact, enhancing operational flexibility.

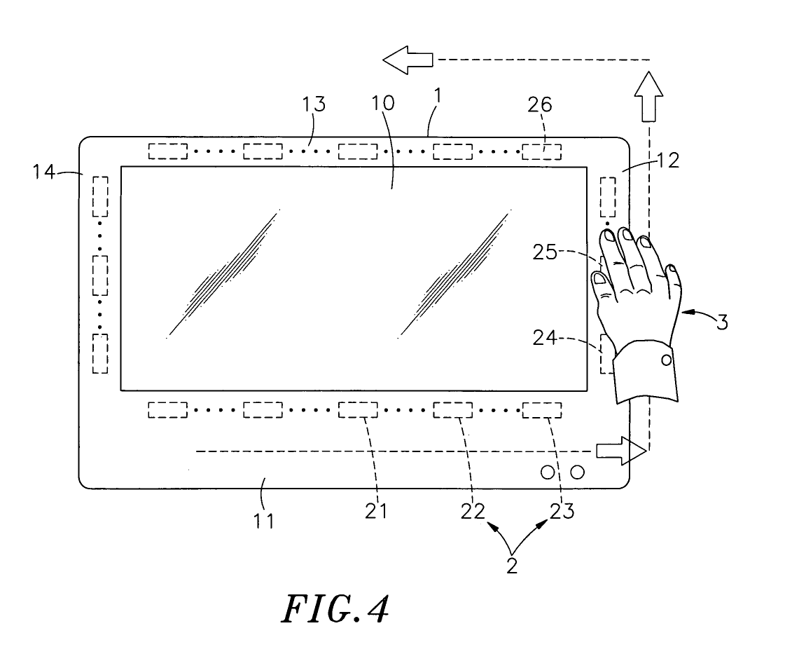

According to the embodiment shown in FIG. 4, the electronic device 1 has a first sensor 21, a second sensor 22 and a third sensor 23 installed in the first peripheral side 11, a fourth sensor 24 and a fifth sensor 25 installed in the second peripheral side 12, and a sixth sensor 26 installed in the third peripheral side 13. The user can move the hand continuously over the sensors from 1^{st} through 6^{th}, causing the sensors to produce a respective sensing signal. By means of the aforesaid calculation formula, the control module computes the moving direction, speed and distance of the user's hand, thereby obtaining the related operating parameter for a corresponding operational control, for example, picture rotation.

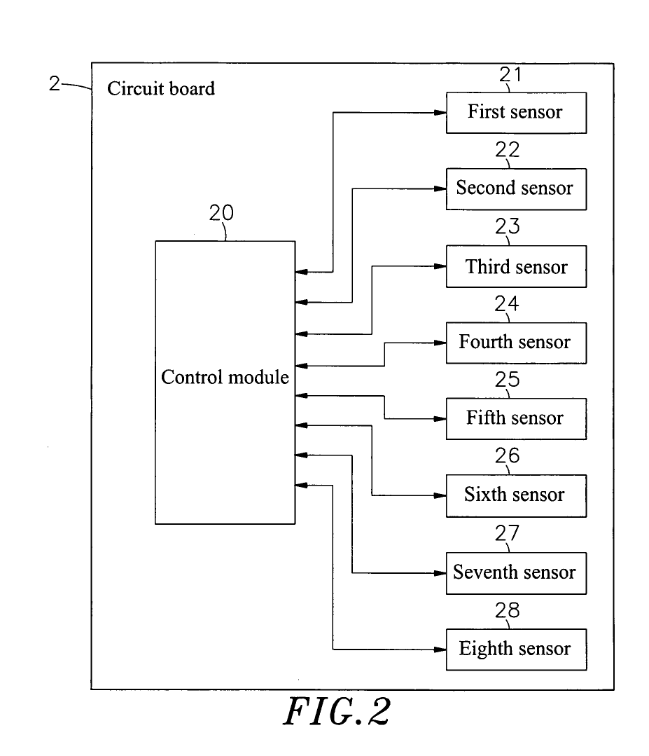

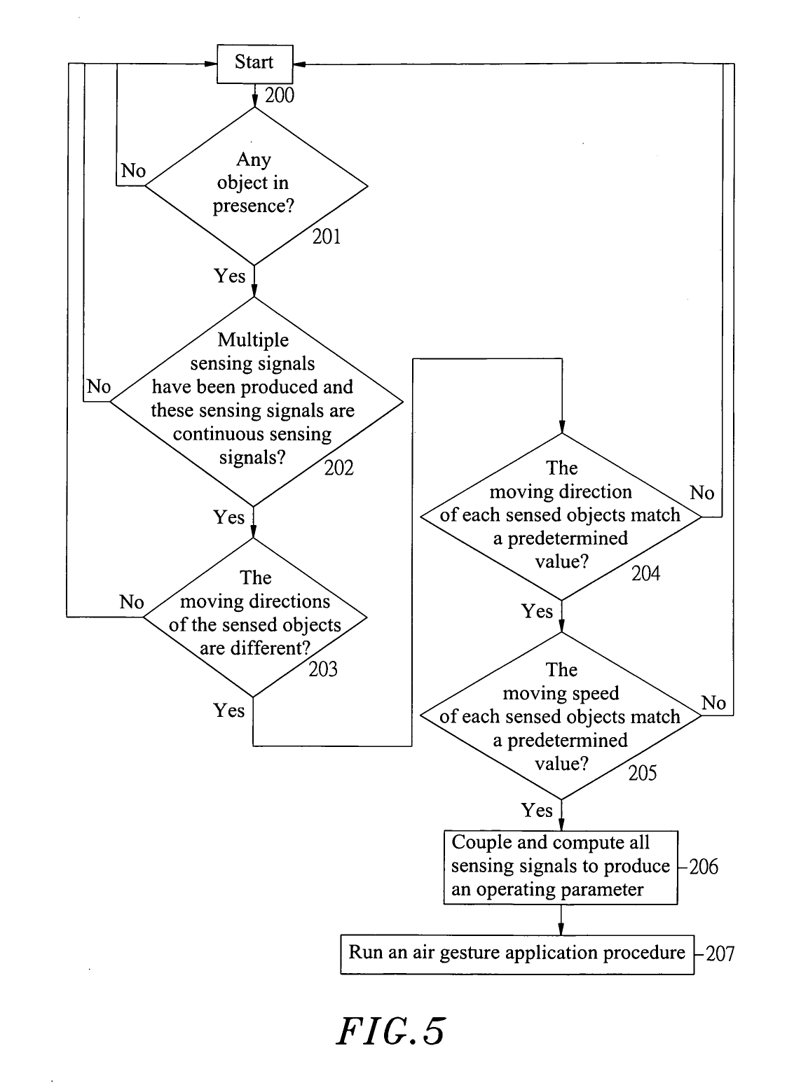

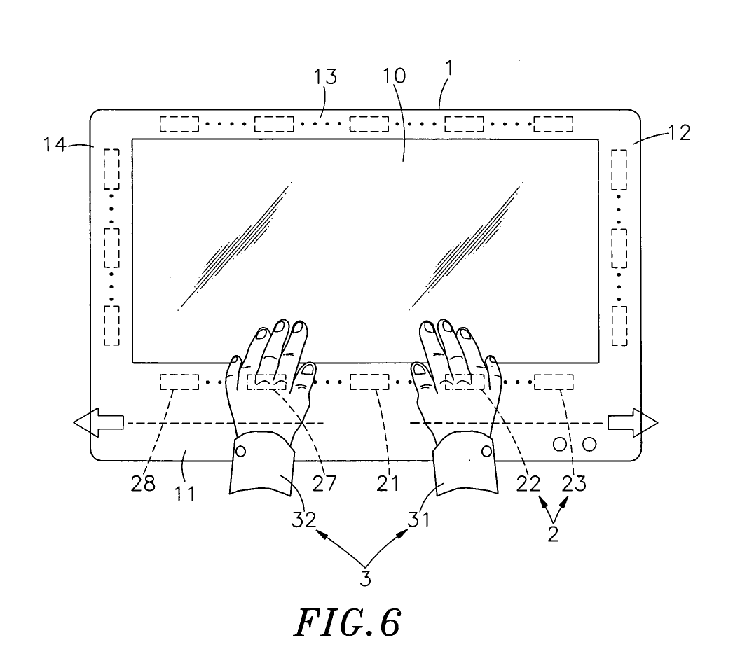

Referring to FIGS. 5 and 6 and FIG. 2 again, an air gesture recognition type electric device operating method in accordance with a second embodiment of the present invention uses multiple objects 3 for operating an electronic device 1 by air gestures. According to this second embodiment, the electronic device 1 has multiple sensors installed in the peripheral sides thereof. For example, the electronic device 1 has the first sensor 21, the second sensor 22, the third sensor 23, the seventh sensor 27 and the eighth sensor 28 installed in the first peripheral side 11 thereof and electrically connected to the control module 20 at the circuit board 2 therein. The air gesture recognition type electronic device operating method in accordance with the second embodiment of the present invention includes the steps of:
(200) Prepare an electronic device 1 having multiple sensors in each of the peripheral sides thereof, and then provide multiple objects 3 for approaching the sensors of the electronic device 1 to produce sensing signals
(201) Determine whether or not at least one object 3 is approaching, and then proceed to step (202) when positive, or return to step (200) when negative;
(202) Determine whether or not multiple sensing signals have been produced and these sensing signals are continuous sensing signals, and then proceed to step (203) when positive, or return to step (201) when negative;
(203) Determine whether or not the moving directions of the sensed objects 3 are different, and then proceed to step (204) when the moving directions are different, or return to step (201) when the moving directions are same;
(204) Determine whether or not the moving direction of each sensed object 3 matches a predetermined value, and then proceed to step (205) when positive, or return to step (201) when negative;
(205) Determine whether or not the moving speed of each sensed object 3 matches a predetermined value, and then proceed to step (206) when positive, or return to step (201) when negative;
(206) Couple and compute all sensing signals to produce an operating parameter; and
(207) Run an air gesture application procedure.

When one object 3 enters the set sensing range of the sensors, the procedure as explained in the aforesaid first embodiment is performed. This second embodiment will detect whether or not a second one of the objects 3 enters the set sensing range of the sensors after detection of the approaching of a first one of the objects 3. By means of the control module 20, it determines whether or not the moving directions of the sensed objects 3 are different. If the moving directions of the sensed objects 3 are different, it is indicated that multiple objects 3 are simultaneously appeared to operate the electronic device 1.

For example, when a first object 31 and a second object 32 enter the sensing range of the first sensor 21, second sensor 22, third sensor 23, seventh sensor 27 and eighth sensor 28, these sensors 21;22;23;27;28 respectively provide a respective sensing signal to the control module 20. At this time, the control module 20 makes judgment. When the first object 31 enters the sensing range of the first sensor 21, second sensor 22 and third sensor 23 and then moves from the set sensing range of the first sensor 21 into the set sensing range of the third sensor 23, the sensing is judged to be a continuous sensing, and the movement of the first object 31 is judged by the control module 20 to be from the left toward the right. Relatively, when the second object 32 enters the sensing range of the seventh sensor 27 and the eighth sensor 28 and moves from the set sensing range of the seventh sensor 27 into the set sensing range of the eighth sensor 28, the sensing is judged to be a continuous sensing, and the movement of the second object 32 is judged by the control module 20 to be from the right toward the left. Subject to the relative relationship of movement of the sensed objects 3, the control module 20 judges that multiple objects 3 are in movement, and then determines whether or not the moving direction and speed of each sensed object 3 match respective predetermined values, and then couples and analyzes all the received sensing signals to produce an operating parameter, for example, zoom in, and then runs the zoom-in application procedure. Thus, multiple objects 3 are applicable for controlling the operation of the electronic device 1.

Further, when one object 3 enters a predetermined range relative to the electronic device 1, the sensors provide a respective sensing signal to the control module 20, causing the control module 20 to start up power supply for the other modules of the electronic device 1, putting the other modules of the electronic device 1 into standby mode. Thus, power consumption is minimized when the electronic device 1 is not operated.

In conclusion, the invention provides an air gesture recognition type electronic device operating method, which has advantages and features as follows:
1. The invention allows a user to operate the electronic device 1 by means of air gesture without direct contact. The electronic device 1 has multiple sensors installed in each multiple peripheral sides thereof. When a designated object 3 enters the sensing range of the sensors, the control module 20 of the electronic device 1 determines whether or not the sensing of the sensors is a continuous sensing, and then determines whether or not the sensing signals of the sensors match predetermined values in, for example, moving direction and moving speed, and then couples and analyzes all the received sensing signals to produce an operating parameter, and then runs an application procedure subject to the operating parameter. Thus, one single structure of the electronic device 1 can run an air gesture recognition type operating procedure, saving the hardware cost and enhancing operational flexibility.
2. The air gesture recognition type operation control is a non-contact operation control. When multiple objects 3 are applied for operation control, the control module 20 will determine whether or not there are continuous movements of multiple objects in different directions. When continuous movements of multiple objects are detected, the control module 20 couples and computes the sensing signals obtained from the sensors to produce an operating parameter, and then uses this operating parameter to run a corresponding application procedure. Thus, the invention provides the electronic device 1 with a versatile operational method.
3. When one sensor senses one object 3 in presence, it provides a sensing signal to the control module 20, enabling the control module 20 to switch the electronic device 1 from standby mode into operating mode. Thus, the invention saves power consumption when the electronic device 1 is not operated.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. An air gesture recognition type electronic device operating method, comprising the steps of:
(a) Prepare an electronic device having multiple sensors in each of multiple peripheral sides thereof, and then provide at least one object for approaching said sensors of said electronic device to produce sensing signals;
(b) Determine whether or not one said object is approaching, and then proceed to step (c) when positive, or return to step (a) when negative;
(c) Determine whether or not said object has been continuously sensed, and then proceed to step (d) when positive, or return to step (b) when negative;
(d) Determine whether or not the moving direction of one said object matches a predetermined value, and then proceed to step (e) when positive, or return to step (b) when negative;
(e) Determine whether or not the moving speed of said object matches a predetermined value, and then proceed to step (f) when positive, or return to step (b) when negative;
(f) Couple and compute all received sensing signals to produce an operating parameter; and
(g) Run an air gesture application procedure subject to the produced operating parameter.

2. The air gesture recognition type electronic device operating method as claimed in claim 1, wherein the sensors of said electronic device prepared in step (a) are selected from a group consisting of capacitive sensors and infrared sensors.

3. The air gesture recognition type electronic device operating method as claimed in claim 1, wherein step (b) of determining whether or not one said object is approaching is achieved by means of the sensing operation of said sensors to detect the presence of one said object within a predetermined range X relative to one said sensor.

4. The air gesture recognition type electronic device operating method as claimed in claim 1, wherein each said sensing signal received in step (f) comprises the data of the moving direction of the sensed object, the distance between the sensed object and the respective sensor and the moving speed of the sensed object.

5. The air gesture recognition type electronic device operating method as claimed in claim 1, wherein step (f) of coupling and computing all received sensing signals to produce an operating parameter is done by means of the calculation formula of Ag=S₁{f(d), f(t)}·S₂{f(d), f(t)} . . . S_{y}{f(d), f(t)}, where: Ag (air gesture operation)=the operating parameter; S=sensor; S₁=the first sensor; S₂=the second sensor; S_{y}=the y^{th} sensor; f(d)=the distance between the sensed object and the respective sensor; f(t)=the moving time from one sensor to a next sensor.

6. The air gesture recognition type electronic device operating method as claimed in claim 1, wherein when one said object is sensed by one said sensor in step (b), said electronic device is switched from a power-saving mode to an operating mode.

7. An air gesture recognition type electronic device operating method, comprising the steps of:
(a) Prepare an electronic device having multiple sensors in each of multiple peripheral sides thereof, and then provide multiple objects for approaching said sensors of said electronic device to produce sensing signals;
(b) Determine whether or not one said object is approaching, and then proceed to step (c) when positive, or return to step (a) when negative;
(c) Determine whether or not multiple sensing signals have been produced and whether or not these sensing signals are continuous sensing signals, and then proceed to step (d) when positive, or return to step (b) when negative;
(d) Determine whether or not the moving directions of the sensed objects are different, and then proceed to step (e) when the moving directions are different, or return to step (b) when the moving directions are same;
(e) Determine whether or not the moving direction of each sensed object matches a predetermined value, and then proceed to step (f) when positive, or return to step (b) when negative;
(f) Determine whether or not the moving speed of each sensed object matches a predetermined value, and then proceed to step (g) when positive, or return to step (b) when negative
(g) Couple and compute all received sensing signals to produce an operating parameter; and
(h) Run an air gesture application procedure subject to the produced operating parameter.

8. The air gesture recognition type electronic device operating method as claimed in claim 7, wherein the sensors of said electronic device prepared in step (a) are selected from a group consisting of capacitive sensors and infrared sensors.

9. The air gesture recognition type electronic device operating method as claimed in claim 7, wherein when one said object is sensed by one said sensor in step (b), said electronic device is switched from a power-saving mode to an operating mode.

10. The air gesture recognition type electronic device operating method as claimed in claim 7, wherein step (b) of determining whether or not one said object is approaching is achieved by means of the sensing operation of said sensors to detect the presence of one said object within a predetermined range X relative to one said sensor.

11. The air gesture recognition type electronic device operating method as claimed in claim 7, wherein each said sensing signal received in step (f) comprises the data of the moving direction of the sensed object, the distance between the sensed object and the respective sensor and the moving speed of the sensed object.

12. The air gesture recognition type electronic device operating method as claimed in claim 7, wherein step (f) of coupling and computing all received sensing signals to produce an operating parameter is done by means of the calculation formula of Ag=S₁{f(d), f(t)}·S₂{f(d), f(t)} . . . S_{y}{f(d), f(t)}, where: Ag (air gesture operation)=the operating parameter; S=sensor; S₁=the first sensor; S₂=the second sensor; S_{y}=the y^{th} sensor; f(d)=the distance between the sensed object and the respective sensor; f(t)=the moving time from a first time point t₁ at one said sensor to a second time point t₂ at a next sensor.
